(19) United States
(12) Patent Application Publication
(10) Pub. No.: US 2012/0313808 A1
(43) Pub. Date: Dec. 13, 2012

(54) Method and Apparatus for Mitigating an Effect of User Movement in Motion Detecting Radar

(75) Inventor: Kerry D. Frohling, Fullerton, CA (US)

(73) Assignee: RAYTHEON COMPANY, Waltham, MA (US)

(21) Appl. No.: 13/156,185

(22) Filed: Jun. 8, 2011

(51) Int. Cl. G01S 13/08

(52) U.S. Cl. 342/90

(57) ABSTRACT

A method includes receiving a reflection of Radio Frequency (RF) radar energy, mapping the RF radar energy by Doppler frequency and range, analyzing the RF radar energy for a highest return, aligning the highest return with a Doppler notch over a range of interest, and searching for targets within the RF radar energy only outside of the Doppler notch.

### GOVERNMENT LICENSE RIGHTS

This invention was made with government support under contract number H94003-04-D-0006 awarded by U.S. Army Communications Electronics Research Development & Engineering Center. The government has certain rights in the invention.

### FIELD OF THE INVENTION

This disclosure relates in general to motion detecting radar and, more particularly, to techniques for mitigating the effects of user movement in motion detecting radar systems.

### BACKGROUND

Various government agencies, such as law-enforcement agencies and homeland security agencies, as well as militaries are involved in operations where it would be desirable to be able to see through a wall or other barrier. For instance, if a law enforcement agent is planning to break down a door, it would be helpful if the law enforcement agent knew what was behind the door.

Motion sensing radar provides one promising solution. For instance, motion sensing radar can be used to sense motion on the other side of a wall or barrier, which provides a good indicator of location of a person who may be optically obscured. However, one technical issue that remains is how to mitigate the effects of user movement when a motion detecting radar system is in the field.

### SUMMARY

According to one embodiment, a method includes receiving a reflection of Radio Frequency (RF) radar energy, mapping the RF radar energy by Doppler frequency and range, analyzing the RF radar energy at each range for a highest return aligning the highest return with a Doppler notch, and searching for targets within the RF radar return only outside of the Doppler notch.

According to another embodiment, a radar system that mitigates an effect of device movement or user movement includes a transceiver unit adapted to emit Radio Frequency (RF) signals and to detect reflected RF signals and a processor unit adapted to: indentify a largest amplitude return of the reflected RF signals within a Doppler frequency space for a plurality of ranges, align a Doppler filter notch and the largest amplitude return for the plurality of ranges, and identify targets using data outside of the Doppler frequency notch. The radar system also includes a user interface unit adapted to provide output indicating the target.

According to yet another embodiment, a computer program product has a computer readable medium tangibly recording computer program logic for processing radar data. The computer program product includes code to create the radar data from received RF signals, code to identify a largest amplitude return within a Doppler frequency space in the radar data at a non-zero Doppler frequency value, and code to align the largest amplitude return and a Doppler filter notch to define a target exclusion zone in the Doppler frequency space and a target search zone in the Doppler frequency space.

### BRIEF DESCRIPTION OF THE DRAWINGS

A better understanding of the present invention will be realized from the detailed description that follows, taken in conjunction with the accompanying drawings, in which:

FIG. 1 is an illustration of an exemplary method for mitigating the effects of device or user movement, according to one embodiment.

FIG. 2 is an illustration of an exemplary range-Doppler map.

FIG. 3 is an illustration of an exemplary cross-section at given range across Doppler frequencies of interest.

FIG. 4 is an illustration of a deployment scenario for a radar system adapted according to one embodiment.

### DETAILED DESCRIPTION

Various embodiments provide techniques to mitigate the effects of user or device movement on a motion detecting radar system. Specifically, various embodiments are directed to handheld radar systems for use in military and law enforcement applications, but the scope of embodiments is not so limited. Various embodiments may be adapted for use in applications other than for military and law enforcement (e.g., for commercial use). Furthermore, various embodiments may be directed to radar systems that are not handheld but nevertheless experience movement by the unit that may cause undesired false alarms or missed targets.

In one example embodiment, a motion detecting radar system provides a user interface that alerts a human user to movement within the system's field of view. For instance, the radar system uses an algorithm to analyze radar returns and detect movement of objects. The user interface may provide a visual and/or audible indication of the movement, including an approximate direction and range of the movement.

Continuing with the example embodiment, the radar emits Radio Frequency (RF) radiation and receives a return as the RF energy is reflected. The system processes the return to create an arrangement of data that provides a relationship between Doppler frequency and range. The data is arranged as a plurality of Doppler filter bins, where each of the Doppler filter bins is associated with a range. The system then looks for the largest amplitude return within the Doppler filter bins for the ranges of interest.

The present embodiment assumes that the largest amplitude return over a given range corresponds to stationary clutter. Stationary clutter can be caused by a variety of objects, but usually encompasses large objects, such as walls, trees, and signs that reflect a large amount of energy. For the purposes of motion detecting radar, such clutter is typically a hindrance. In a scenario wherein a radar unit is perfectly still and wherein a clutter object is perfectly still, the Doppler frequency of the object's return should be zero. However, if the radar unit moves, the clutter return may appear to be at a Doppler frequency other than zero, which may trigger a false detection or mask legitimate targets. It is desirable to identify as many legitimate targets as possible, as well as to eliminate as many false alarms as possible.

The present example embodiment provides features that help to mitigate the effects of movement. As mentioned above, the radar system analyzes the return to identify the largest amplitude return within the Doppler filter bins over the range of interest. The system then aligns the Doppler filter notch and the highest return. In one process, the Doppler filter notch is fixed to be centered at zero Doppler frequency, and the system re-centers the data so that the highest return corresponds to a zero Doppler frequency. In another process, the system shifts the Doppler filter notch within the Doppler frequency space to align with the highest return. Whichever process is used, the highest return is aligned with a center of a Doppler filter notch.

The Doppler filter notch can be any appropriate width, but in some embodiments is ten Doppler filter bins wide or less. The system eliminates portions of the return that fall within the Doppler filter notch. The remaining data is then processed to identify moving targets. Accordingly, the Doppler filter notch may sometimes be referred to as a “target exclusion zone,” whereas Doppler filter bins outside of the Doppler filter notch may sometimes be referred to as a “target search zone.”

The above-described processes, in this example embodiment, are performed many times per second. A single two-dimensional arrangement of Doppler filter bins corresponding to a single time value can be referred to as a frame. The above-described processes may be performed for each frame, where the system may generate multiple frames per second. In some embodiments, a smoothing process is performed frame-to-frame before the highest returns are identified in order to diminish noise within the clutter return.

The above-identified example embodiment is for illustration purposes only, and the scope of embodiments is not limited to the details described above. The following figures are used to describe another embodiment for a handheld radar system.

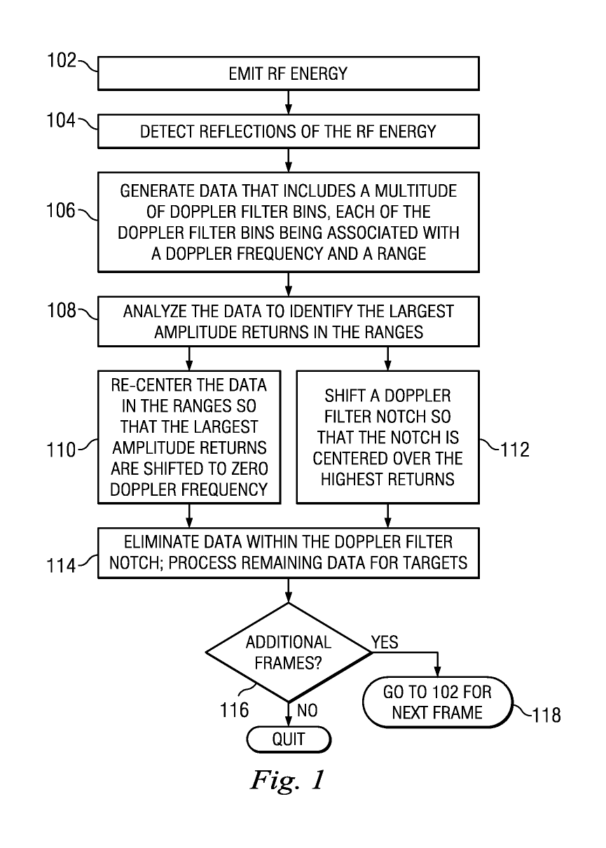

FIG. 1 is an illustration of exemplary method 100, adapted according to one embodiment. Method 100 may be performed by one or more modules in a radar system, where such modules may execute computer-readable code providing functionality described herein.

In block 102, the radar system emits RF energy. The RF energy radiates outwardly and is reflected by objects. For instance, some of the reflections may be from background clutter, such as walls, buildings, trees, signs, etc., whereas other reflections may be from targets, such as people or machines that are moving within the scene.

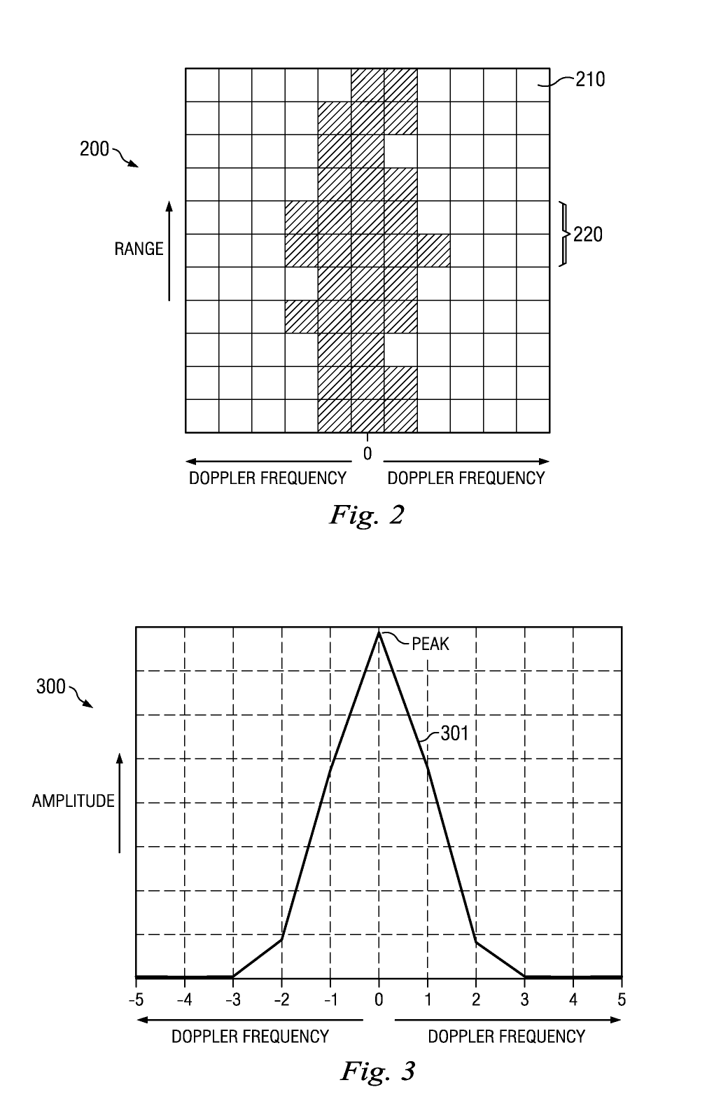

In block 104, the radar system detects reflections of the RF energy. In block 106, data is generated from the reflected RF energy. The data includes a multitude of Doppler filter bins, each of the Doppler filter bins being associated with a Doppler frequency and a range. Each Doppler filter bin includes a portion of data that indicates a strength (or amplitude) of the return. An example data structure with multiple Doppler bins is shown in FIG. 2.

FIG. 2 is an illustration of exemplary range-Doppler map 200. The y-axis is a range axis. The x-axis is a Doppler frequency axis, and it is centered at zero. The magnitude of Doppler frequency increases in either direction from zero. Each of the rectangles, such as rectangle 210, represents a Doppler filter bin.

Some of the bins around zero are shaded, indicating in this example a high amplitude return. Each row of map 200 includes a plurality of Doppler bins for a particular range value.

FIG. 2 is a mere 11×11 matrix, and it is understood that data in a real-life example may include many more Doppler filter bins for a given frame. Furthermore, the map 200 of FIG. 2 is a visual representation of the data stored in memory and manipulated by one or more processors in the radar system, and map 200 is shown to provide an understanding of Doppler bin data. A real-life radar system may not actually produce a visual representation of the Doppler bins, such as shown in FIG. 200. It is also understood that the range-Doppler map of FIG. 2 is illustrative of a single frame and that various embodiments may produce many frames per second.

Returning to the example of FIG. 1, in block 108, the data is analyzed to identify the largest amplitude returns for the ranges of interest. In some examples, data in every range is analyzed, and in other examples, data from only a portion (e.g., every other range) is analyzed. As mentioned above, it is assumed in these embodiments that the largest amplitude returns are associated with stationary clutter.

Returning to FIG. 2, bins around the center are shaded, indicating a higher return, which is a common scenario. Further in this example, range bins 220 show a high return over a range of Doppler frequencies and may be indicative of, e.g., a wall or other clutter.

Moving to FIG. 3, an exemplary cross-section across Doppler frequencies of interest for range 300 is shown, such range data may be analyzed in block 108 of FIG. 1. Range 300 includes a y-axis indicating a radar return amplitude and an x-axis indicating Doppler frequency. Range 300 may represent one of the rows of range-Doppler map 200 of FIG. 2. Curve 301 is a plot of the amplitude of the return at a given Doppler frequency value.

It should be noted that in both FIG. 2 and FIG. 3, the highest amplitude returns are centered around zero Doppler frequency. Such a scenario is possible when the radar unit (and its user) are completely still and when large clutter objects are also completely still. However, in many field use scenarios, such as when a human user carries or otherwise moves the radar unit, such movement will cause the highest amplitude returns to deviate from a zero-Doppler frequency center. The embodiment of FIG. 1 provides features to mitigate this effect of device movement.

Returning to FIG. 1, blocks 110 and 112 provide alternative operations for mitigating the effect of device movement in a motion detecting radar system. In block 110, the data is re-centered in the ranges so that the largest amplitude returns are shifted to zero Doppler frequency. The operation of block 110 may be associated with an embodiment that has a fixed Doppler notch, and the data is shifted to fit the Doppler notch. In other words, it is possible to normalize the data within the frequency space to account for an observed phenomenon—in this case, a Doppler frequency shift for clutter returns.

In block 112, the Doppler filter notch is shifted so that the notch is centered over the highest returns. Thus, in block 112, a Doppler filter notch itself may be adaptively moved as appropriate to account for the Doppler frequency shift in the clutter returns. Some embodiments may perform the operation of block 110, whereas other embodiments may perform the operation of block 112. Some embodiments may even be able to perform both. The scope of embodiments is not limited to the operations of blocks 110 and 112. In fact, any technique now known or later developed to ensure alignment of a high amplitude return with a Doppler filter notch may be included in some embodiments.

In block 114, the data within the Doppler filter notch is eliminated. In some embodiments, the data within the Doppler filter notch is erased from memory, though the scope of embodiments is not so limited. In some embodiments, the data within the Doppler filter notch may simply be ignored for the purpose of searching for targets. Further in block 114, the remaining data is processed to search for targets. For instance, some returns outside of the Doppler filter notch may have a Doppler frequency and amplitude indicative of a moving person or machine. More advanced processing (not described further herein) may be used to analyze returns within the target search areas to distinguish targets from non-target objects.

In block 116 if the method 100 continues with further frames, then at block 118 the method 100 is repeated again. Otherwise, process 100 quits.

Various embodiments are not limited to the exact process shown in FIG. 1. Rather, some embodiments may add, omit, rearrange, or modify one or more actions as appropriate for a given application. For instance, some embodiments include a filter that smoothes the data from frame to frame (e.g., over five consecutive frames) to ameliorate the effects of noise. Furthermore, some embodiments include additional steps not described in detail above, such as providing an indication to a human user of detected movement.

Moreover, some embodiments may include a more adaptable Doppler filter notch. For instance, some embodiments allow the Doppler filter notch shape to adaptively change depending on the clutter conditions. Adaptively narrowing the Doppler filter notch may increase sensitivity to slower moving targets than would be otherwise possible. Adaptively widening the Doppler filter notch where clutter shows high dispersion due to wide angle scatterers or multipath may reduce the false alarm rate.

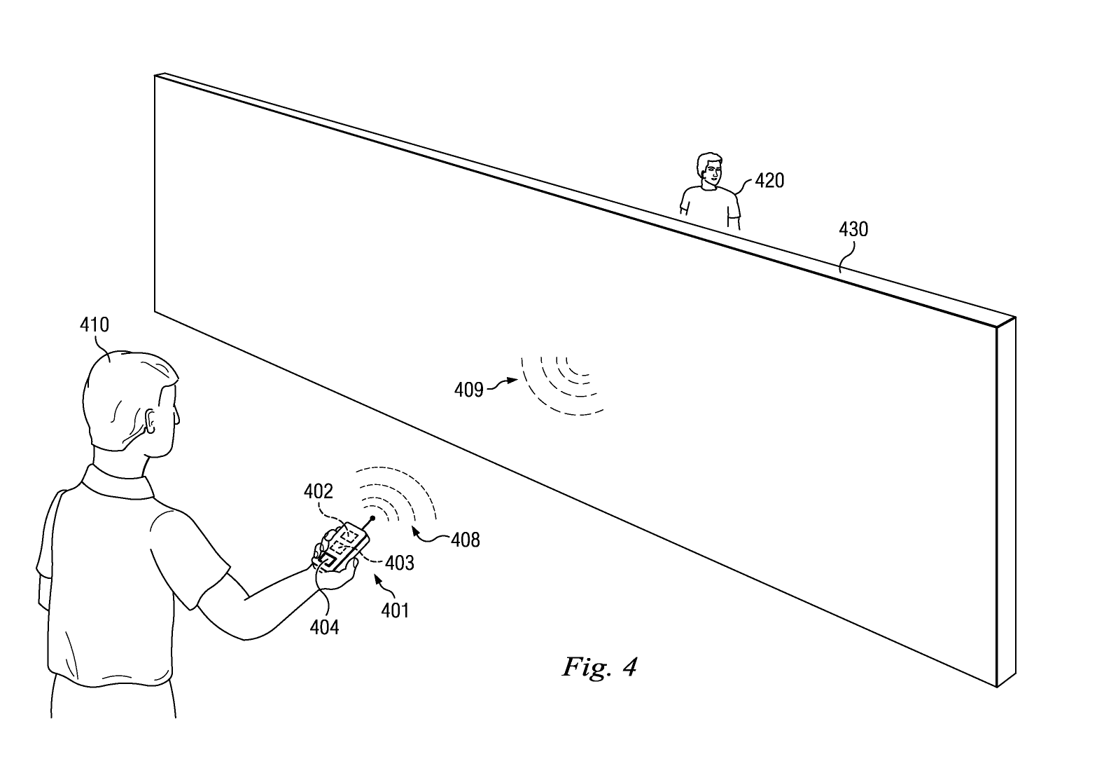

FIG. 4 is an illustration of an exemplary field deployment scenario for one embodiment. Human user 410 operates handheld radar system 401 to search for target 420. However, target 420 is behind wall 430.

As explained above, it is expected that the return associated with wall 430 will be a high-amplitude return that is centered close to zero Doppler frequency. However, if human user 410 causes movement of radar system 401, then the return for wall 430 may deviate somewhat from zero Doppler frequency. Radar system 401 uses a process, such as method 100 of FIG. 1, to ameliorate the effects of movement of radar system 401.

Radar system 401 includes transceiver unit 402, which emits RF radiation 408 and detects reflected RF radiation 409. Processing unit 403 includes one or more processor-based devices that generate and analyze data from the detected RF radiation 409. Processing unit 403 compensates for Doppler clutter shift, as explained in more detail above. User interface unit 404 receives commands from user 410 and provides audio or video output for user 410.

When implemented via computer-executable instructions, various elements of some embodiments are in essence the software code defining the operations of such various elements. The executable instructions or software code may be obtained from a tangible readable medium (e.g., a hard drive media, optical media, RAM, EPROM, EEPROM, tape media, cartridge media, flash memory, ROM, memory stick, network storage device, and/or the like). In fact, readable media can include any medium that can store information.

Processing unit 403 may include, for example, a general purpose CPU, which may execute the various logical instructions according to embodiments of the present disclosure. For example, one or more CPUs may execute machine-level instructions according to the exemplary operational flows described above in conjunction with FIG. 1. Moreover, embodiments of the present disclosure may be implemented on application specific integrated circuits (ASICs) digital signal processors (DSPs), or other specialized processing circuits. In fact, persons of ordinary skill in the art may utilize any number of suitable structures capable of executing logical operations according to the embodiments of the present disclosure.

Various embodiments include one or more advantages. For instance, some implementations do not perform complex mathematical operations on the data, instead simply identifying the largest magnitude returns and ensuring that the largest returns are aligned with a Doppler filter notch. Such features makes a software, firmware, or hardware implementation of method 100 (FIG. 1) relatively “lightweight.” Thus, some embodiments may be implemented into motion detecting radar systems without overburdening the processing capabilities. With this in mind, however, it is noted that the scope of embodiments does not exclude processes with a higher degree of computational complexity.

Additionally, various embodiments may be especially adaptable to handheld radar systems. Preliminary simulations show a noticeable increase in an amount of user movement that can be tolerated when using the method of FIG. 1. Thus, such embodiments may add value to radar systems deployed in missions where user movement is expected. While the previous example discusses handheld radar systems, the scope of embodiments may include radar systems that are vehicle mounted or are otherwise expected to experience movement that may cause a Doppler frequency shift for clutter.

Although selected embodiments have been illustrated and described in detail, it should be understood that a variety of substitutions and alterations are possible without departing from the spirit and scope of the present invention, as defined by the claims that follow.

What is claimed is:

1. A method comprising:
receiving a reflection of Radio Frequency (RF) radar energy;
mapping the RF radar energy by Doppler frequency and range;
analyzing the RF radar energy for a highest return;
aligning the highest return with a Doppler notch; and
searching for targets within the RF radar energy only outside of the Doppler notch.

2. The method according to claim 1, in which aligning the highest return with the Doppler notch comprises:
centering the highest return at a zero Doppler frequency.

3. The method according to claim 1, in which aligning the highest return with the Doppler notch comprises:
moving the Doppler notch within a Doppler frequency space to align with the highest return.

4. The method according to claim 1, performed in a handheld radar system.

5. The method according to claim 1, in which the highest return corresponds to stationary clutter.

6. The method according to claim 1, in which mapping the RF radar energy comprises:
generating a plurality of Doppler filter bins, each of the Doppler filter bins being arranged by range and Doppler frequency.

7. The method according to claim 6, in which the Doppler notch corresponds to an integer number of Doppler filter bins in each range.

8. The method according to claim 1, further comprising:
performing the receiving, mapping, analyzing, aligning, and searching for a plurality of frames.

9. The method according to claim 8, in which the highest filter return is aligned with the Doppler filter notch for each frame.

10. The method according to claim 8, further comprising:
performing a smoothing algorithm for consecutive ones of the frames.

11. A radar system that mitigates an effect of device movement or user movement, the radar system comprising:
a transceiver unit adapted to emit Radio Frequency (RF) signals and to detect reflected RF signals;
a processor unit adapted to:
indentify a largest amplitude return of the reflected RF signals within a Doppler frequency space for a plurality of ranges;
align a Doppler filter notch and the largest amplitude return for the plurality of ranges; and
identify a target using data outside of the Doppler frequency notch; and
a user interface unit adapted to provide output indicating the target.

12. The radar system according to claim 11, comprising a handheld radar system.

13. The radar system according to claim 11, in which the processor unit is adapted to re-center the largest amplitude return to a zero Doppler frequency value.

14. The radar system according to claim 11, in which the processor unit is adapted to move the Doppler frequency notch to be centered upon the largest amplitude return.

15. A computer program product having a computer readable medium tangibly recording computer program logic for processing radar data, the computer program product comprising:
code to create the radar data from received RF signals;
code to identify a largest amplitude return within a Doppler frequency space in the radar data at a non-zero Doppler frequency value; and
code to align the largest amplitude return and a Doppler filter notch to define a target exclusion zone in the Doppler frequency space and a target search zone in the Doppler frequency space.

16. The computer program product of claim 15 in which the largest amplitude return is defined as stationary clutter.

17. The computer program product of claim 15 in which the code to identify a largest amplitude return comprises:
code to analyze range bins within the radar data to identify one or more peak amplitudes within the range bins.

18. The computer program product of claim 15 in which the code to align comprises:
code to center the Doppler filter notch at the non-zero Doppler frequency.

19. The computer program product of claim 15 in which the code to align comprises:
code to normalize the radar data within the Doppler frequency space so that the largest amplitude return is at a normalized zero Doppler frequency value.

20. The computer program product of claim 15 in which the Doppler filter notch corresponds to an integer number of Doppler filter bins within a range of interest.
